(19) United States
(12) Patent Application Publication
(10) Pub. No.: US 2010/0037004 A1
(43) Pub. Date: Feb. 11, 2010

(54) STORAGE SYSTEM FOR BACKUP DATA OF FLASH MEMORY AND METHOD FOR THE SAME

(75) Inventor: Ju-peng Chen, Taipei City (TW)

Correspondence Address: KIRTON AND MCCONKIE, 60 EAST SOUTH TEMPLE,, SUITE 1800, SALT LAKE CITY, UT, 84111, US

(73) Assignee: GENESYS LOGIC, INC., Shindian City (TW)

(21) Appl. No.: 12/332,145

(22) Filed: Dec. 10, 2008

(30) Foreign Application Priority Data
Aug. 8, 2008 (TW) 097130439

(51) Int. Cl. G06F 12/16; G06F 12/00; G06F 12/02

(52) U.S. Cl. 711/103; 711/162; 711/E12.001; 711/E12.008; 711/E12.103

(57) ABSTRACT

A storage system for backup data of a flash memory includes a flash memory for storing a first file, a detector for detecting a number of accesses to the first file, and a driving unit coupled to the detector. The driving unit is used for duplicating the first file as one or more second files when the number of accesses to the first file exceeds a predetermined value, and storing the one or more first files into the flash memory. If the access number is higher than the predetermined value, which indicates this file is more likely to be accessed, the invention automatically backups this file and accesses the backup file at the next access request for fear that the file is damaged by multiple access to the same file.

### BACKGROUND OF THE INVENTION

1. Field of the Invention

The present invention relates to a storage system and related method, and more specifically, to storage system for backup data of flash memory based on a number of access to files and method for the same.

2. Description of the Related Art

A flash Memory, a non-volatile memory, may keep the previously stored written data upon shutdown. In contrast to other storage media, e.g. hard disks, soft disks, magnetic tapes and so on, the flash memory has advantages of small volume, light weight, vibration-proof, low power consumption, and no mechanical movement delay in data access, therefore, are widely used as storage media in consumer electronic devices, embedded systems, or portable computers.

There are two kinds of flash memory: an NOR flash memory and an NAND flash memory. An NOR flash memory is characteristically of low driving voltage, fast access speed, high stability, and are widely applied in portable electronic devices and communication devices such as Personal Computers (PCs), mobile phones, personal digital assistances (PDAs), and set-top boxes (STBs). An NAND flash memory is specifically designed as data storage media, for example, a Secure Digital (SD) memory card, a Compact Flash (CF) card, a Memory Stick (MS) card.

The NAND flash memory contains a plurality of blocks, and each block has a plurality of pages wherein each page is divided into data area and spare area. The data area may contain 2048 bytes which are used for storing data. The spare area may contain 64 bytes which are used for storing error correction code (ECC).

However, the flash memory may fail to change data update-in-place, that is, prior to writing data into a non-blank page, erasing a block including the non-blank page is required. In general, erasing a block takes as much time as 10-20 times greater than writing into a page. If a size of written data is over an assigned block, the filled pages in the assigned block may have to be removed to other blocks, and then erasing the assigned block is performed.

Furthermore, flash memory blocks may fail to be accessed when in excess of one million times of erasures before the block is considered to be worn out. This is because the number of erasure times for a block is close to one million times when the charge within the floating gate may be insufficient due to current leakage of realized capacitor, thereby resulting in data loss of the flash memory cell, and even a failure of access to the flash memory. In other words, if a block is erased over a limited times, that block may be unable to be accessed. Owing to a life-cycle limitation of the flash memory, how to correctly access data before the block is worn out is an important task. A conventional way is to detect a number of written times of all pages, and then to write data into a least-used page. Nevertheless, a most-used page is not essential to be worn out in the next access time, conversely, a less-used page is possibly to be worn out in the next access time. In other words, the conventional way to select a page to be written relying on the number of access time is not perfect.

### SUMMARY OF THE INVENTION

It is therefore an object of the present invention to provide a storage system which backs-up data repeatedly and automatically. Original files are duplicated in a flash memory as backup data based on a number of accesses to the original files. The backup data is available for access if the original files are damaged.

According to the claimed invention, a storage system for backup data of a flash memory comprises a flash memory for storing a first file, a detector for detecting a number of accesses to the first file, and a driving unit coupling to the detector. The driving unit is used for duplicating the first file as one or more second files when the number of accesses to the first file exceeds a predetermined value, and storing the one or more first files into the flash memory.

In another aspect, the claimed invention provides a method for backup data of a flash memory. The method comprises the steps of detecting a number of accesses to a first file in the flash memory, duplicating a first file as one or more second files when the type of the first file complies to a predetermined type when the number of accesses to the first file exceeds a predetermined value, and for storing the one or more first files into the flash memory.

According to the present invention, the method further comprises a step of randomly accessing the first file or the one or more second files in response to a request to read the first file.

According to the present invention, the method further comprises a step of determining to access the first file or the one or more second files, based on the number of accesses to the first file or the one or more second files, in response to a request to read the first file.

The present invention will be described with reference to the accompanying drawings, which show exemplary embodiments of the present invention.

### BRIEF DESCRIPTION OF THE DRAWINGS

FIG. 1 is a functional block diagram of a system for backup data of a flash memory according to a preferred embodiment of the present invention.

FIG. 2 is a flowchart of a method of storing file in a memory for multi-backup data according to a preferred embodiment of the present invention.

### DETAILED DESCRIPTION OF THE INVENTION

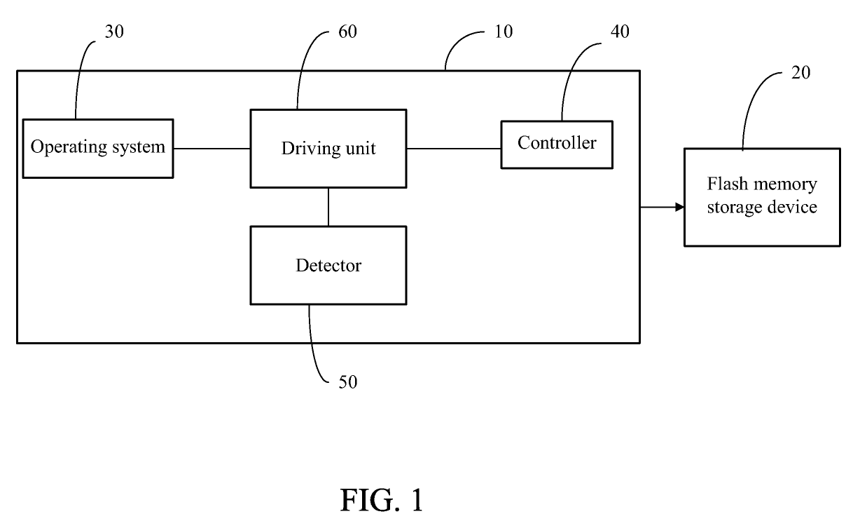

Please refer to FIG. 1. FIG. 1 is a functional block diagram of a system for backup data of a flash memory according to a preferred embodiment of the present invention. The system comprises a host 10 and a flash memory storage device 20. The host 10 may be a desktop computer, a notebook computer, an industry computer, a recordable DVD player, and so on. The host 10 comprises an operating system 30, a controller 40, a driving unit 60, and a detector 50. The flash memory storage device 20 comprises an NAND flash memory for storing data. The flash memory storage device 20 is a Secure Digital (SD) card, a Multi Media Card (MMC), a Compact Flash (CF) card, a Micro Drive (MD) card, a Memory Stick (MS) card, a Smart Media (SM) card, or an eXtreme Digital (XD) card. The driving unit 60 is implemented by a software program code or a hardware circuit.

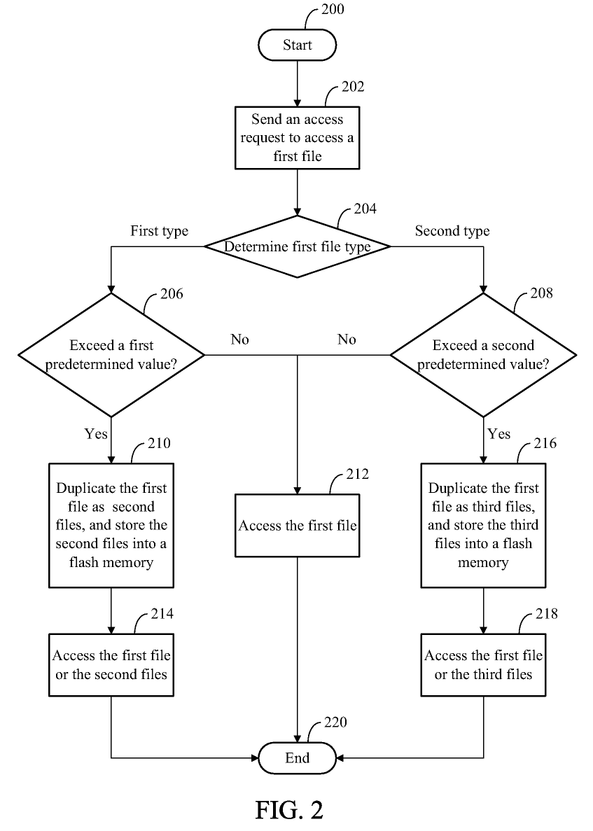

Please refer to FIG. 1 and FIG. 2. FIG. 2 is a flowchart of a method of storing file in a memory 20 for multi-backup data according to a preferred embodiment of the present invention. As shown in FIG. 2, the method comprises steps of:
Step 200: Start.
Step 202: Send an access request to access a first file.
Step 204: Determine the type of the first file, if the first file complies with the first type, go to Step 206; if the first file complies with a second type, go to Step 208.
Step 206: Determine if a number of accesses to the first file exceeds a first predetermined value. If it is, go to Step 210; if not, go to Step 212.
Step 208: Determine if the access number of the first file outnumbers a second predetermined value. If it is, go to Step 218; if not, go to Step 222.
Step 210: Duplicate the first file as one or more second files, and store the one or more second files into a flash memory.
Step 212: Access the first file.
Step 214: Access the first file or the one or more second files.
Step 216: Duplicate the first file as one or more third files, and store the one or more third files into the flash memory.
Step 218: Access the first file or the one or more third files.
Step 220: End.

When the host 10 sends an access request through the operating system 30 to access a file A stored in the flash memory storage device 20 (Step 202), the driving unit 60, in accordance with the access request, drives the controller 40 to access data of the file A stored in the flash memory storage device 20 and to determine the data type of the file A (Step 204). If the file A is an image file, which complies with the first type (e.g MPEG), the driving unit 60 determines the access number of the image file which is detected by the detector 50 (Step 206). If the access number is less than the first predetermined value, which indicates that the access of the file A is still in a first tolerant range, and the file A in the flash memory storage device 20 is directly accessed (Step 212). On the contrary, if the access number exceeds the first predetermined value, which indicates that the access of the file A is over the first tolerant range and the possibility of damage to the file A increases. Therefore the driving unit 60 drives the controller 40 to duplicate the file A as one or more files A′ and stores the one or more files A′ in other unused storage blocks in the flash memory storage device 20 (Step 210). Next, the driving unit 60 drives the controller 40 to access the file A or the one or more files A′ randomly (Step 214). In another embodiment, the driving unit 60 drives the controller 40 to choose an access to the file A or the one or more files A′, which is determined by the access numbers of the file A and the one or more files A′. For example, every time when the file A or the one or more file A′ is accessed, the detector 50 detects and records the access number of the file. Assumed that the detector 50 finds the access number of the file A is more than that of the file A′, the driving unit 60 drives the controller 40 to access the file A′ in response to the next access request. As a result, the access numbers of the file A or the file A′ are evenly distributed.

If the file A is a text file, the driving unit 60 determines the access number of the text file which is detected by the detector 50 (Step 208). If the access number is less than a second predetermined value, which indicates that the access of the file A is still in a second tolerant range, and the file A in the flash memory storage device 20 is directly accessed (Step 212). On the contrary, if the access number exceeds the second predetermined value, indicating that the access of the file A is over the second tolerant range and the possibility of damage to the file A increases. Therefore the driving unit 60 drives the controller 40 to duplicate the file A as one or more files A″ and stores the one or more files A″ in other unused storage blocks in the flash memory storage device 20 (Step 216). Next, the driving unit 60 drives the controller 40 to access the file A or the one or more files A″ randomly (Step 218). Preferably, the driving unit 60 defines various tolerant ranges for different file types, e.g. the second tolerant range for text files is greater than the first tolerant range for image files. In another embodiment, whether a file is duplicated or not is only determined based on its access number, Step 204 is no longer performed.

Please note that the file type and the predetermined value can be adjusted relying on the designer's needs. The embodiment mentioned above is an account for the invention, not for confining a scope of the invention.

Compared to the prior art, based on the present invention, if the access number is higher than the predetermined value, which indicates this file is more likely to be accessed, the invention automatically backs-up this file and accesses the backup file at the next access request for fear that the file be damaged by multiple access to the same file.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A storage system for backup data of a flash memory comprising:
a flash memory for storing a first file;
a detector for detecting a number of accesses to the first file; and
a driving unit coupled to the detector, for duplicating the first file as one or more second files when the number of accesses to the first file exceeds a predetermined value, and storing the one or more first files into the flash memory.

2. The storage device of claim 1 wherein the flash memory is an NAND flash memory.

3. The storage device of claim 1, wherein the driving unit is further used for determining a type of the first file.

4. The storage device of claim 3, wherein the driving unit is used for duplicating the first file as one or more second files when the type of the first file complies to a predetermined type, and when the number of accesses to the first file exceeds a predetermined value, and for storing the one or more first files into the flash memory.

5. The storage device of claim 1, wherein the driving unit is used for randomly accessing the first file or the one or more second files in response to a request to read the first file.

6. The storage device of claim 1, wherein the driving unit is used for determining to access the first file or the one or more second files, based on the number of accesses to the first file or the one or more second files, in response to a request to read the first file.

7. A method for backup data of a flash memory comprising:
detecting a number of accesses to a first file in the flash memory;
duplicating the first file as one or more second files when the number of accesses to the first file exceeds a predetermined value, and storing the one or more first files into the flash memory.

8. The method of claim 7 wherein the flash memory is an NAND flash memory.

9. The method of claim 7, further comprising:
determining a type of the first file in the flash memory.

10. The method of claim 9, further comprising:
duplicating the first file as one or more second files when the type of the first file complies to a predetermined type, and when the number of accesses to the first file exceeds a predetermined value, and for storing the one or more first files into the flash memory.

11. The method of claim 10, further comprising:
randomly accessing the first file or the one or more second files in response to a request to read the first file.

12. The method of claim 7, further comprising:
determining to access the first file or the one or more second files, based on the number of accesses to the first file or the one or more second files, in response to a request to read the first file.
